(19) United States
(12) Patent Application Publication
(10) Pub. No.: US 2003/0057038 A1
(43) Pub. Date: Mar. 27, 2003

(54) Drum brake linings having thermally or mechanically applied metallic shoe attachment enhancements

(76) Inventors: Sunil K. Kesavan, Troy, MI (US); Roy A. Eastham, Novi, MI (US); Kent L. Fairless, Troy, MI (US)

Correspondence Address: Honeywell International Inc., 101 Columbia Road, P.O. Box 2245, Morristown, NJ, 07962, US

(21) Appl. No.: 09/962,068

(22) Filed: Sep. 25, 2001

(51) Int. Cl. F16D 69/00

(52) U.S. Cl. 188/250 B; 188/250 R

(57) ABSTRACT

Drum brake linings having an integral surface texture on the friction side surface of a drum brake shoe are described. The surface texture may be achieved by spraying metal droplets onto the surface, fusing a metal pattern onto the surface, or creating a series of protrusions by scraping or cutting the surface. The surface textures have excellent shear strength and retention profiles.

### BACKGROUND OF THE INVENTION

The present invention relates generally to friction linings, and more particularly to drum linings having metallic attachment applied thermally to a surface of the drum shoe, or alternatively, formed on a surface of the drum shoe, for use in applications such as, but not limited to drum-in-hat style parking brakes.

An automotive vehicle's parking brake mechanically applies the rear brakes (or front brakes in some vehicles) to hold the vehicle stationary while it is stopped or parked. The parking brake is typically operated by a hand lever or by a foot pedal. There are two general types of parking brakes, integral and independent.

Integral parking brakes have parts that are common to both the service brakes and the parking brakes. For example, a rear drum brake can be used as a parking brake by attaching a parking-brake lever to the rear brake shoe. A parking-brake link or strut is placed between the two brake shoes. When the parking-brake cable is pulled by the hand lever or foot pedal, it causes the parking-brake lever to pivot. The upper end of the lever forces the rear shoe into contact with the drum. At the same time, the section below the pivot forces the link or strut forward. This pushes the front shoe into the drum and applies the parking brake.

With respect to a rear disc brake, the caliper typically has a piston that can be operated either hydraulically or mechanically. A large screw threads into a nut-and-cone assembly that fits inside the piston. When the vehicle operator applies the parking brake, the parking-brake cable pulls the lever which rotates the screw. The nut then pushes the piston out. This forces the shoes into contact with the disc and applies the parking brake.

Conversely, independent parking brakes do not share parts with the service brakes. One example of an independent parking brake is known as the so-called “drum-in-hat” style parking brake, which essentially is a drum-type parking brake used with rear-wheel disc-type service brakes. Generally speaking, this type of arrangement employs a set of relatively small brake shoes which fit into a hub provided on a disc-drum assembly. The hub's interior surface serves as a brake drum. When the parking brake is deployed, the brake shoes are brought into contact with the interior surface of the hub, thus preventing the vehicle from moving.

Recently, there has been particular interest in the parking brake shoes employed in the drum-in-hat style parking brake systems. The brake shoes typically include a generally U-shaped support or bracket having a friction lining secured to the outer surface of the support, i.e., the surface intended to face the interior surface of the hub of the disc/drum assembly. Typically, the friction material is secured to the support by an adhesive.

With increasing thermal performance and durability requirements being imposed on service and drum-in-hat parking brake linings, the need for reliable mechanical attachment techniques to keep the linings attached to the shoe during high temperature conditions is paramount. Unfortunately, conventional adhesives do not possess the required thermal stability to provide reliable attachment at the high temperatures often encountered during operation of automobiles.

Therefore, there exists a need for a brake lining for a parking shoe, and methods of making same, wherein the brake lining is reliably mechanically attached to the parking shoe without the need for adhesives.

### SUMMARY OF THE INVENTION

In accordance with a first embodiment of the present invention, a brake element is provided, comprising: (1) a drum lining member; and (2) a plurality of metal droplets disposed on a surface of the drum shoe member.

In accordance with a second embodiment of the present invention, a brake element is provided, comprising: (1) a drum lining member; and (2) a metal pattern thermally fused onto a surface of the drum shoe member

In accordance with a third embodiment of the present invention, a brake element is provided, comprising: (1) a drum lining member; and (2) a plurality of protrusions formed on a surface of the drum shoe member.

A more complete appreciation of the present invention and its scope can be obtained from the following brief description of the drawings, detailed description of the invention, and the appended claims.

### BRIEF DESCRIPTION OF THE DRAWINGS

The present invention will become more fully understood from the detailed description and the accompanying drawings, wherein:

FIG. 1 is an illustration of a perspective view of method for applying a metal spray onto the surface of a brake element, in accordance with the general teachings of the present invention;

FIG. 2 is an illustration of a perspective view of method for fusing a metal pattern onto the surface of a brake element, in accordance with the general teachings of the present invention;

FIG. 3 is an illustration of a perspective view of method for forming protrusions onto the surface of a brake element, in accordance with the general teachings of the present invention;

FIG. 4 is a photographic illustration of perspective view of several different types of brake elements having various surface textures, in accordance with the general teachings of the present invention;

FIG. 5 is a graphical illustration of the shear strength of two samples of brake elements having a metal spray applied onto the surface thereof, in accordance with the general teachings of the present invention;

FIG. 6 is a graphical illustration of the retention profile of two samples of brake elements having a metal spray applied onto the surface thereof, in accordance with the general teachings of the present invention;

FIG. 7 is a graphical illustration of the comparative shear strength of three samples of brake elements having protrusions formed on the surface thereof versus several conventional brake elements, in accordance with the general teachings of the present invention; and

FIG. 8 is a graphical illustration of the comparative retention profile of three samples of brake elements having protrusions formed on the surface thereof versus several conventional brake elements, in accordance with the general teachings of the present invention.

The same elements or parts throughout the figures are designated by the same reference of characters.

### DETAILED DESCRIPTION OF THE INVENTION

The following description of the preferred embodiment(s) is merely exemplary in nature and is in no way intended to limit the invention, its application, or uses.

In accordance with one embodiment of the present invention, the use of a mechanical attachment involving the use of thermally applied metal particles on the shoe surface is proposed. These attachment techniques provide sufficiently high shear strength and retention under high temperature usage conditions.

Non-limiting examples of the thermally applied metal attachment include but are not limited to the use of a metal spray and a fusible metal pattern.

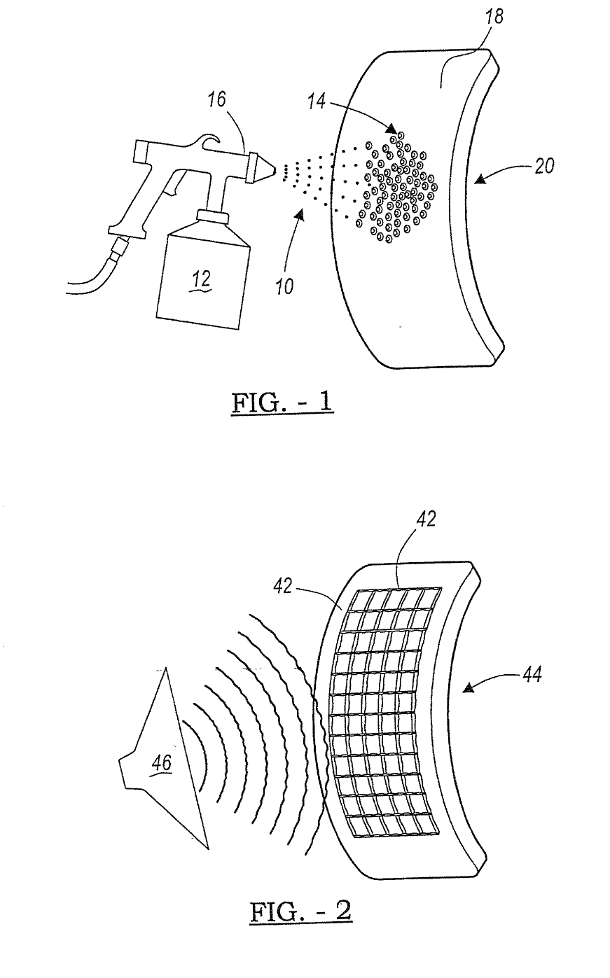

The metal spray techniques involves the application of molten metal, as a spray, onto a surface of the shoe. The metal spray is preferably applied to the friction side of drum linings. Referring to FIG. 1, the application of the metal spray 10 can be achieved in any number of conventional methods, such as but not limited to heating a source 12 of metal and then causing the heated metal to form droplets 14 which are then sprayed from a nozzle 16 (e.g., via a stream of air) against the friction surface side 18 of a drum shoe 20. The exact pattern of the droplets 14 is not thought to be critical, provided that there is sufficient coverage to form an effective material coating on the friction side surface 18 of the drum shoe 20. By way of a non-limiting example, a weight per unit area of about 1 gram/cm² is acceptable.

Referring to FIG. 2, the fusible metal powder pattern technique involves placing a powder metal pattern 40 onto the friction side surface 42 of the drum lining 44 and then exposing the metal pattern 40 to a heat source 46 for a sufficient period of time to cause the powder metal pattern 40 to melt and fuse onto the friction side surface 42 of the drum shoe 44. The exact pattern of the metal pattern 40 is not thought to be critical, provided that there is sufficient coverage to form an effective coating on the friction side surface 42 of the drum shoe 44 for attachment of a friction material. In both cases, the end result is a one-piece (i.e., integral) friction lining suitable for use in both service and parking brake applications, wherein the friction material will not become separated from the drum shoe.

In accordance with an alternative embodiment of the present invention, the use of a mechanical attachment involving the use of mechanical manipulation of the friction side surface of the drum lining is proposed. Like, the previously described attachment techniques, this technique also provides sufficiently high shear strength and retention under high temperature usage conditions.

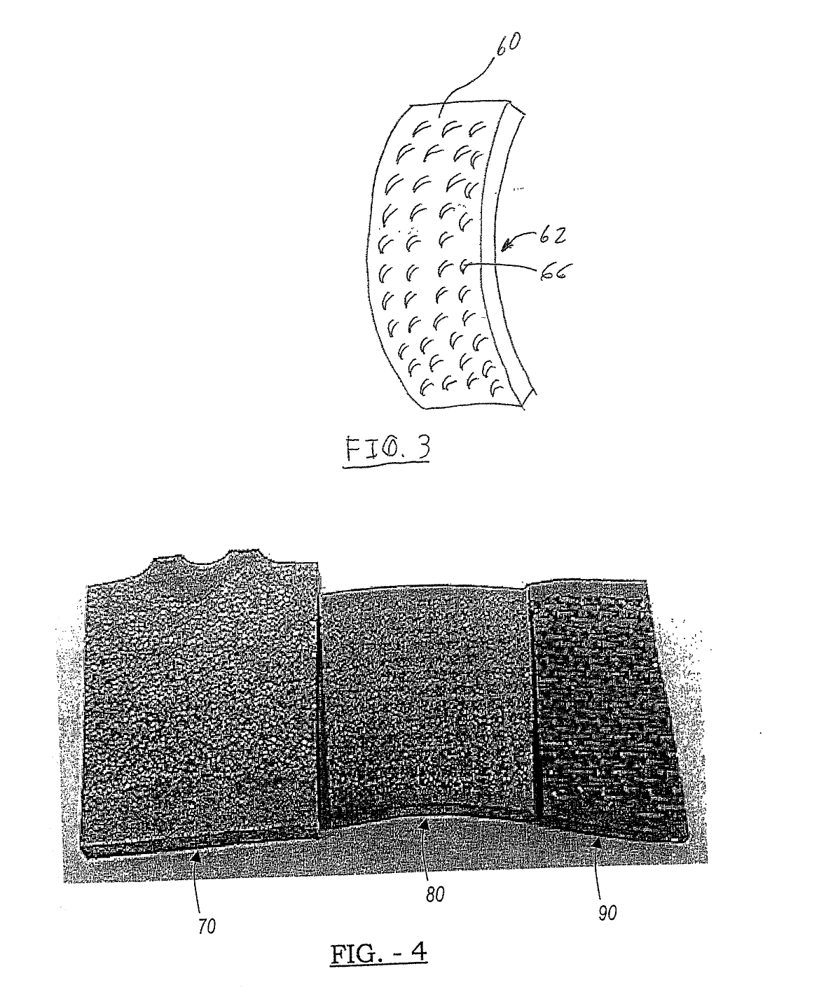

Referring to FIG. 3, the mechanical manipulation of the friction side surface 60 of the drum shoe 62 can be accomplished, by way of a non-limiting example, by using a tool such as a rasp, to partially displace portions of the friction side surface 60 of the drum shoe 62 to create a pattern of hook-shaped protrusions 66. Preferably, the protrusions 66 are substantially aligned and oriented in the same general direction. However, they may also be arranged in alternating rows, with one row having a first orientation, and the adjacent row having a second opposite orientation. The exact pattern of the protrusions 66 is not thought to be critical, provided that there is sufficient coverage to form an effective attachment of friction material to the surface 60 of the drum shoe 62. Additionally, an optional primer may be applied to provide corrosion and rust protection. Again, the end result is a one-piece (i.e., integral) friction lining suitable for use in both service and parking brake applications, wherein the friction material will not become separated from the drum lining.

Referring to FIG. 4, there is shown a drum lining 70 having a metal spray applied thereto, a drum lining 80 having a metal pattern fused thereto, and a drum lining 90 having a pattern of protrusions formed thereon.

In order to evaluate the shear strength and retention characteristics of the various embodiments of the present invention, several experiments were carried out.

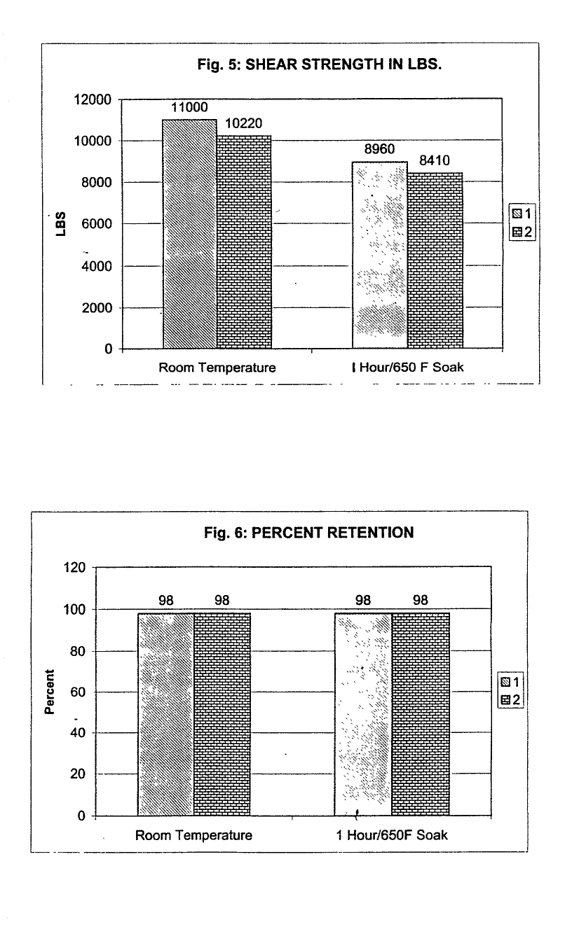

Referring to FIG. 5, two samples, designated 1 and 2, of drum linings having a metal spray applied to the friction side surface of the shoe were evaluated for shear strength. One test was conducted at room temperature and the other test was conducted after a one hour soak at 650° F. As the test data indicates, both samples performed very well with respect to shear strength.

Referring to FIG. 6, the same two samples, 1 and 2, were evaluated for retention of the friction material. Again, one test was conducted at room temperature and the other test was conducted after a one hour soak at 650° F. As the test data indicates, both samples performed extremely well with respect to retention.

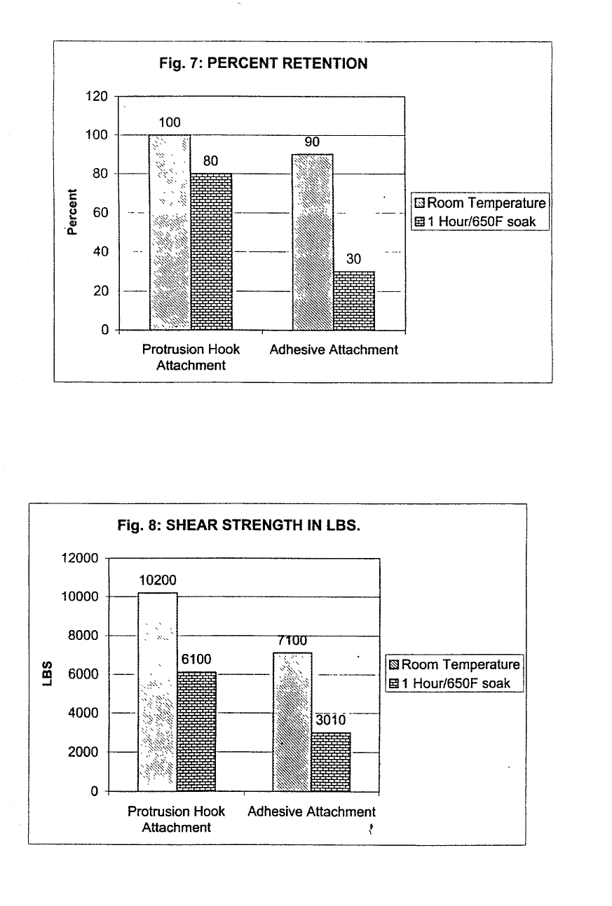

Referring to FIG. 7, a sample according to the invention designated as protrusion/hook attachment having a series of protrusions formed to the friction side surface of the shoe, were compared against conventional drum linings (using adhesive on the shoe) with respect to retention. One test was conducted at room temperature and the other test was conducted after a one hour soak at 650° F. As the test data indicates, the samples with the protrusion/hook attachment in accordance with the present invention performed very well as compared to the conventional drum linings.

Referring to FIG. 8, identical samples as in FIG. 7 were evaluated for shear strength of the bond between friction material and shoe. Again, one test was conducted at room temperature and the other test was conducted after a one hour soak at 650° F. As the test data indicates, the samples in accordance with the present invention performed extremely well with respect to shear strength, as compared to the other conventional drum linings.

The foregoing description is considered illustrative only of the principles of the invention. Furthermore, because numerous modifications and changes will readily occur to those skilled in the art, it is not desired to limit the invention to the exact construction and process shown as described above. Accordingly, all suitable modifications and equivalents that may be resorted to that fall within the scope of the invention as defined by the claims that follow.

What is claimed is:

1. A drum brake lining, comprising:
a drum brake shoe member having a plurality of protrusions disposed on a surface thereof; and
a friction material member attached to said surface of the drum brake shoe member.

2. A drum brake lining according to claim 1, wherein said plurality of protrusions are formed from a plurality of metal droplets sprayed onto the surface of the brake shoe member.

3. A drum brake lining according to claim 2, wherein the plurality of metal droplets are sprayed onto the surface of the drum brake shoe member so as have a weight per unit area of about 1 g/cm².

4. A drum brake lining according to claim 1 wherein said plurality of protrusions are formed from a powder metal pattern thermally fused onto said surface.

5. A drum brake lining according to claim 4, wherein the powder metal pattern has a lattice configuration.

6. A drum brake lining according to claim 6, wherein the plurality of protrusions are formed by applying a scraping force to said surface of the drum brake shoe member.

7. A drum brake shoe having a plurality of protrusions disposed on a friction material side surface thereof.

8. A drum brake shoe according to claim 7, wherein said plurality of protrusions are formed from a plurality of metal droplets sprayed onto said friction material side surface.

9. A drum brake shoe according to claim 7, wherein said plurality of protrusions are formed from a plurality of metal droplets sprayed onto said friction material side surface.

10. A drum brake shoe according to claim 9, wherein the plurality of metal droplets are sprayed onto the surface of the drum brake shoe so as have a weight per unit area of about 1 g/cm².

11. A drum brake shoe according to claim 7, wherein said plurality of protrusions are formed from a powder metal pattern thermally fused onto said surface.

12. A drum brake shoe according to claim 11, wherein the powder metal pattern has a lattice configuration.

13. A drum brake shoe according to claim 7, wherein the plurality of protrusions are formed by applying a scraping force to said surface of the drum brake shoe.
